(19) United States
(12) Patent Application Publication
(10) Pub. No.: US 2026/0196538 A1
(43) Pub. Date: Jul. 9, 2026

(54) Ascertaining The Moisture Of A Gas Flow At A Measuring Point Of A Fuel Cell System

(71) Applicant: Schaeffler Technologies AG & Co. KG, Herzogenaurach (DE)

(72) Inventors: Stephan Heinrich, Pfeffenhausen (DE); Thorsten Knittel, Pentling (DE)

(73) Assignee: Schaeffler Technologies AG & Co. KG, Herzogenaurach (DE)

(21) Appl. No.: 19/128,328

(22) PCT Filed: Nov. 1, 2023
(86) PCT No.: PCT/EP2023/080445

§ 371 Date: May 8, 2025

(30) Foreign Application Priority Data
Nov. 8, 2022 (DE) 10 2022 211 807.3

(51) Int. Cl. H01M 8/04119; G01N 25/56; H01M 8/0444; H01M 8/04492; H01M 8/04664

(52) U.S. Cl. CPC H01M 8/04179; H01M 8/04447; H01M 8/045; H01M 8/04664; G01N 25/56

(57) ABSTRACT

Some embodiments of the teachings herein include a method for ascertaining a humidity of a gas stream at a measuring point in a fuel cell system comprising the measuring point and a reference point chosen such that the gas stream has approximately equal hydrogen-to-nitrogen ratios at the reference point and the measuring point, the reference point chosen such that the gas stream has a known humidity at the reference point. An example includes: measuring the hydrogen-to-nitrogen ratio of the gas stream at the measuring point using a first sensor; measuring the hydrogen-to-nitrogen ratio of the gas stream at the reference point using a second sensor; and ascertaining the humidity of the gas stream at the measuring point based at least in part on a difference between the first and the second hydrogen-to-nitrogen ratio.

### CROSS-REFERENCE TO RELATED APPLICATIONS

This application is a U.S. National Stage Application of International Application No. PCT/EP2023/080445 filed Nov. 1, 2023, which designates the United States of America, and claims priority to DE Application No. 10 2022 211 807.3 filed Nov. 8, 2022, the contents of which are hereby incorporated by reference in their entirety.

### TECHNICAL FIELD

The present disclosure relates to fuel cells. Various embodiments of the teachings herein include systems and/or methods for ascertaining humidity of a gas stream at a measuring point in a fuel cell system.

### BACKGROUND

In a fuel cell system, nitrogen can accumulate at the anode of the fuel cell stack. This accumulation leads to disruption of the reaction of hydrogen with oxygen, which results in a loss of efficiency for the fuel cell.

The moisture content of the proton exchange membrane of the fuel cell system may also complicate operations. This is in a range from 70% to 80% relative atmospheric humidity. In order to achieve these operating conditions, the air on the cathode side is moistened in order to operate the fuel cell at the optimum efficiency. However, excessive humidity of the gas stream can hinder gas diffusion. Humidity produced by the reaction of hydrogen with oxygen can be an additional disruptive factor that further increases the humidity of the gas stream. The effects that occur are difficult to predict.

To achieve defined conditions on the fuel cell or to counteract the performance-reducing effects, nitrogen and excess water are removed from the fuel cell by suddenly opening valves in the so-called flushing lines. Such a process is called a flushing process. Since the necessary monitoring sensors are absent from the fuel cells, this flushing process is carried out at regular intervals of time, regardless of whether such a flushing process is necessary. As a result, hydrogen is wasted, which means that the range of a vehicle that is operated with such a fuel cell is reduced during frequent but unnecessary flushing processes.

The document CN 112490473 A discloses a humidity management system.

The document CN 113346110 A discloses a measuring device.

The document US 7858258 B2 discloses a fuel cell process.

The document US 10090544 B2 discloses a fuel cell system.

The document US 20060134480 A1 discloses a humidity sensor.

The document CN 113540529 A discloses a measuring system.

### SUMMARY

The teachings of the present disclosure provide alternative methods that make the use of a moisture sensor for ascertaining the moisture in a gas stream in a fuel cell system superfluous.

Some embodiments of the teachings herein include a fuel cell system or a vehicle by means of which such a method can be carried out. For example, some embodiments of the teachings herein include a method for ascertaining (3) a humidity of a gas stream at a measuring point in a fuel cell system (7), the fuel cell system (7) comprising the measuring point and a reference point, the measuring point and the reference point being chosen such that the gas stream has approximately the same hydrogen-to-nitrogen ratio at the reference point and the measuring point, the reference point being chosen such that the gas stream has a known humidity at the reference point, comprising: measuring (1) the hydrogen-to-nitrogen ratio of the gas stream at the measuring point by means of a first sensor (9), measuring (2) the hydrogen-to-nitrogen ratio of the gas stream at the reference point by means of a second sensor (10), and ascertaining (3) the humidity of the gas stream at the measuring point on the basis of the difference between the hydrogen-to-nitrogen ratios measured by means of the two sensors (9, 10).

In some embodiments, the two sensors (9, 10) measure each of the hydrogen-to-nitrogen ratios on the basis of the thermal properties of the gas stream.

In some embodiments, the two sensors are calibrated identically.

In some embodiments, the method further comprises initializing (5) a flushing process if the humidity of the gas stream at the measuring point exceeds a threshold value for the humidity of the gas stream.

In some embodiments, the method further comprises initializing a load-point-controlled or time-dependent flushing process if it is detected that at least one of the sensors has a malfunction.

In some embodiments, the method further comprises: performing a diagnosis on the two sensors by temporarily forming the gas stream by way of a moistureless reference gas, and detecting a malfunction in at least one of the two sensors on the basis of a measurement signal difference between the two sensors.

As another example, some embodiments include a fuel cell system (7) having a control unit (11), a first and a second sensor (9, 10), and a measuring point and a reference point, the first sensor (9) being arranged at the measuring point and the second sensor (10) being arranged at the reference point, the measuring point and the reference point being chosen such that a gas stream passing the measuring point and the reference point has approximately the same hydrogen-to-nitrogen ratio at the reference point and the measuring point, the reference point being chosen such that the gas stream has a known humidity at the reference point, characterized in that the control unit (11) is designed to perform one or more of the methods described herein.

As another example, some embodiments include a vehicle (6) having a fuel cell system (7) as described herein.

As another example, some embodiments include a computer program (12) comprising commands that cause one or more of the devices (6, 7) described herein to carry out one or more of the methods described herein.

As another example, some embodiments include a computer-readable medium (13) storing a computer program (12) as described herein.

### BRIEF DESCRIPTION OF THE DRAWINGS

Developments of the teachings of the present disclosure are described in the dependent claims and in the description of the figures that follows. The teachings are explained in detail below on the basis of exemplary embodiments with reference to the drawings, in which:

FIG. 1 shows a vehicle incorporating teachings of the present disclosure; and

FIG. 2 shows an example method for initializing a flushing process for a fuel cell system incorporating teachings of the present disclosure.

### DETAILED DESCRIPTION

Some embodiments of the teachings herein include a method for ascertaining a humidity of a gas stream at a measuring point in a fuel cell system, the fuel cell system comprising the measuring point and a reference point, the measuring point and the reference point being chosen such that the gas stream has approximately the same hydrogen-to-nitrogen ratio at the reference point and the measuring point, the reference point being chosen such that the gas stream has a known humidity at the reference point, wherein the method comprises the steps of measuring the hydrogen-to-nitrogen ratio of the gas stream at the measuring point by means of a first sensor, measuring the hydrogen-to-nitrogen ratio of the gas stream at the reference point by means of a second sensor, and ascertaining the humidity of the gas stream at the measuring point on the basis of the difference between the hydrogen-to-nitrogen ratios measured by means of the two sensors. Such a method allows a humidity sensor for measuring the humidity of the gas stream to be abandoned and eliminated, which affords cost advantages.

The humidity of the gas stream means the proportion of liquid vapor or water vapor in the gas stream. Approximately the same, that is to say an approximately identical, hydrogen-to-nitrogen ratio means a maximum variance of 8%, 5%, 3% or 1% between the hydrogen-to-nitrogen ratios at the two points. In some embodiments, the instead of an approximately identical hydrogen-to-nitrogen ratio, there may be the same hydrogen-to-nitrogen ratio at the two points.

In some embodiments, the gas stream is a gas stream mixture that comprises hydrogen and/or nitrogen. The gas stream means a gas volume flow rate or a gas volume flow rate.

In some embodiments, ascertaining the humidity of the gas stream at the measuring point on the basis of the difference between the hydrogen-to-nitrogen ratios measured by means of the two sensors comprises a calculation, in particular based on the two measured hydrogen-to-nitrogen ratios. In some embodiments, the ascertainment involves using a table, a family of characteristic curves or a transfer function, which are predetermined. These can be determined mathematically or experimentally.

In some embodiments, the first sensor is arranged at the measuring point and/or the second sensor is arranged at the reference point. This allows a direct measurement by means of the sensor or sensors at the respective point.

In some embodiments, the measuring point is at the anode of a fuel cell stack of a fuel cell system.

The known humidity mean a constant value, for example 95%, or a range of values, for example 90% to 98%. In some embodiments, this is understood to mean a value of 100% or approximately 100% humidity.

In some embodiments, the reference point is a point or position in the region of a water separator or on a water separator. Such a water separator may be part of the fuel cell system and serves to extract humidity from the gas stream. In some embodiments, the water separator is arranged in such a way that humidity can be removed from the gas stream by means of the water separator. In some embodiments, the second sensor, as seen in the direction of flow of the gas stream, is arranged upstream, in particular directly upstream, or downstream, in particular directly downstream, of the water separator.

In some embodiments, the hydrogen-to-nitrogen ratio or ratios is/are the hydrogen-to-nitrogen ratio or hydrogen-to-nitrogen ratios of the gas stream.

In some embodiments, the difference between the hydrogen-to-nitrogen ratios measured by means of the two sensors is calculated by way of a subtraction operation on measurement signals from the two sensors. Each of the sensors generates a measurement signal that is representative of and/or proportional to the hydrogen-to-nitrogen ratio.

In some embodiments, the two sensors measure or ascertain each of the hydrogen-to-nitrogen ratios on the basis of the thermal properties of the gas stream. In some embodiments, the thermal properties are the thermal capacity or thermal conductivity of the gas stream. In some embodiments, the sensors are the same sensors.

In some embodiments, each of these sensors comprises a heater and a temperature sensor at a distance from the heater. The heater is used to heat the gas of the gas stream, wherein the temperature rise measured by the temperature sensor, the temperature rise characteristic or the time elapsed before a certain temperature has been reached can be taken as a basis for drawing conclusions about the gas composition or gas ratio, in particular the hydrogen-to-nitrogen ratio. The differences in temperature rise, temperature rise characteristic or time elapsed before a certain temperature has been reached are based on the thermal capacity and/or thermal conductivity of the gas of the gas stream, as this depends on the gas composition or gas ratio.

In some embodiments, both the first and the second sensor comprise a measuring chamber designed in such a way that the gas of the gas stream can penetrate the measuring chamber, but the gas has no or a negligible flow velocity. A negligible flow velocity is a flow velocity that does not affect or hardly affects the measurement of the respective sensor. In some embodiments, the sensors are designed and/or produced in such a way that their heaters and temperature sensors encounter the exact or the same flow velocity of the gas stream to be measured. It is thus possible for the influence of the flow velocity of the gas stream to be eliminated.

In some embodiments, the two sensors are calibrated identically. In some embodiments, they are calibrated in the same manner and/or by means of the same gas, the same gas composition or the same hydrogen-to-nitrogen ratios. The same calibration ensures that the sensors deliver the same measurement signal for the exact same gas concentration. Therefore, the difference between the two measurement signals of the sensors can be used to infer the humidity of the gas stream at the measuring point, since the hydrogen-to-nitrogen ratios are the same at both the measuring point and the reference point, and the difference between the measurement signal at the measuring point and the measurement signal at the reference point is due only to the difference in the humidity of the gas stream at this point compared to the other point.

In some embodiments, each of the two sensors delivers a measurement signal and is calibrated identically, and the difference between the measurement signal of the sensor at the measuring point and the measurement signal of the sensor at the reference point is caused only by the difference between the humidity of the gas stream at the reference point and the humidity of the gas stream at the measuring point. In some embodiments, the two sensors are calibrated for the reference point and would in particular deliver the exact same measurement signal there. Therefore, the difference between the measurement signals is based only on the difference in the humidity of the gas stream at the reference point and at the measuring point, as a result of which the measurement signal difference of the two measurement signals is or can be taken as a basis for ascertaining the humidity of the gas stream at the measuring point. This is possible even though the sensors are gas concentration sensors and not humidity sensors.

In some embodiments, the gas stream has the exact same ratio of gases at the measuring point and the reference point, but its humidity at the two points differs.

In some embodiments, the method further comprises initializing a flushing process if the humidity of the gas stream at the measuring point exceeds a threshold value for the humidity of the gas stream. This is preferably part of an evaluation, in particular an evaluation of the measured values of the two sensors.

For this purpose, it is conceivable to provide for an evaluation unit, which may be implemented in a control unit. In some embodiments, this is a predefined threshold value, the threshold value being a limit value. In this way, the humidity of the gas stream is reduced, as the gas stream is supplied with ambient air.

In some embodiments, the ambient air can be pre-treated ambient air. In some embodiments, the treatment is a temperature control means, a filtration or a water separation.

When this process is carried out, the method is a method for initializing a flushing process for a fuel cell system. This method is used to reduce the humidity of the gas stream. In addition, the flushing process is initialized only if it is really necessary, that is to say the humidity of the gas stream at the measuring point exceeds a predefined threshold value.

In some embodiments, the method further comprises initializing a load-point-controlled or time-dependent flushing process if it is detected that at least one of the sensors has a malfunction. This prevents a flushing process from failing to initialize if one of the two sensors has a fault. The time dependence of the flushing process means in particular that a flushing process is initialized no later than after a certain, predefined time, this period of time being chosen such that the humidity of the gas stream at the measuring point is certain to remain below the threshold value or another threshold value.

In some embodiments, the method further comprises performing a diagnosis on the two sensors by temporarily forming the gas stream by way of a moistureless reference gas and meanwhile detecting a malfunction in at least one of the two sensors on the basis of a measurement signal difference between the two sensors. In this case, the gas stream may be formed completely by way of the reference gas. In some embodiments, the elements are carried out simultaneously.

In some embodiments, the reference gas is hydrogen, in particular pure hydrogen. In some embodiments, these method steps are carried out before the fuel cell system is started. In some embodiments, a measurement signal difference of no more than 1.5%, 5.5%, 8.5% or 10% is permitted before a malfunction in at least one of the sensors is detected. This means that a malfunction is detected if the maximum values of the measurement signal difference are exceeded. The measurement signal difference is produced in particular by the difference between the two measurement signals generated by the two sensors. The maximum values of the measurement signal difference from which a malfunction is detected are in particular predefined by what difference in the hydrogen-to-nitrogen ratios of the gas stream at the measuring point and the reference point can be expected, and are therefore preferably higher.

Some embodiments include a fuel cell system having a control unit, a first and a second sensor, and a measuring point and a reference point, the first sensor being arranged at the measuring point and the second sensor being arranged at the reference point, the measuring point and the reference point being chosen such that a gas stream passing the measuring point and the reference point has the same hydrogen-to-nitrogen ratio at the reference point and the measuring point, the reference point being chosen such that the gas stream has a known humidity at the reference point, wherein the control unit is designed to perform one or more of the methods described herein.

The methods described above and all those embodiments are applicable to the fuel cell system and/or can be performed by means of the fuel cell system incorporating teachings of the present disclosure. All the design embodiments mentioned above, individually or together, in any combination, are transferable to the fuel cell system.

Some embodiments include a vehicle having such a fuel cell system. The vehicle may include a motor vehicle, which is in particular in the form of an automobile or a truck. In some embodiments, the vehicle has an electric drive, the electric drive in particular being able to be supplied with electrical energy by the fuel cell system. This provides a particularly effective vehicle.

Some embodiments include a computer program comprising commands that cause the fuel cell system, the vehicle or the control unit to carry out one or more of the methods described herein.

Some embodiments include a computer-readable medium storing the computer program. In some embodiments, the computer-readable medium is a volatile or permanent memory. In some embodiments, the computer-readable medium or such a memory is part of the control unit.

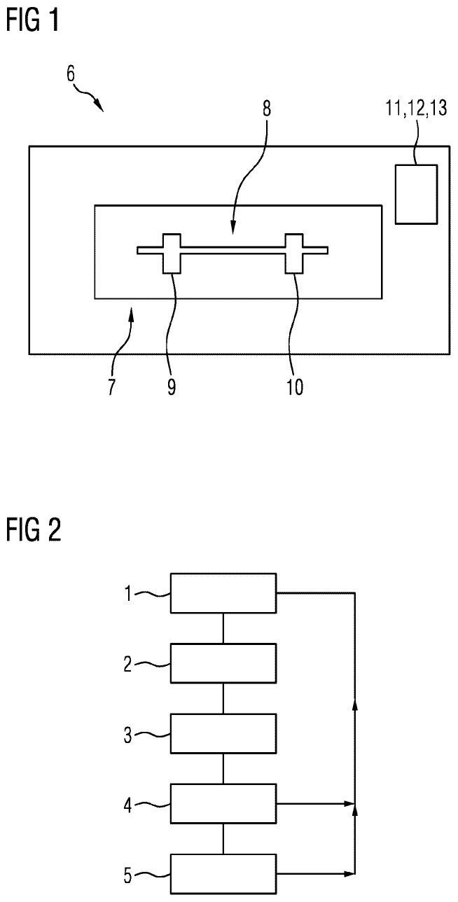

FIG. 1 shows a vehicle 6 incorporating teachings of the present disclosure, which is a motor vehicle having an electric drive and a fuel cell system 7. The fuel cell system 7 supplies the electric drive with electrical energy. The fuel cell system 7 comprises a channel 8 in which a gas stream flows. Two sensors 9, 10 are arranged at a distance from each other and measure hydrogen-to-SUBSTITUTE nitrogen ratios of the gas stream at the respective locations of the sensors 9, 10. The first sensor 9 is arranged at a measuring point in the channel 8, while the second sensor 10 is arranged at a reference point in the channel 8. The reference point is arranged adjacent to a water separator that ensures that a known humidity of the gas stream is produced at this point. The hydrogen-to-nitrogen ratio is identical at the measuring point and the reference point. This allows the humidity of the gas stream at the measuring point to be ascertained on the basis of the different measurement results of the two sensors 9, 10. For this purpose, the vehicle 6 comprises a control unit 11 that comprises a computer-readable medium 12 on which a computer program 13 is stored. The computer program 13 comprises commands that cause the device shown in FIG. 1 to be able to perform the method according to the invention and/or the method that is shown in FIG. 2.

FIG. 2 shows an example method incorporating teachings of the present disclosure, which can be performed by means of the device from FIG. 1. The explanations relate to the device from FIG. 2. First, a measurement 1 is taken by means of the first sensor at the measuring point. The measurement 1 is a measurement of the hydrogen-to-nitrogen ratio of the gas of the gas stream based on the thermal conductivity of the gas of the gas stream. At the same time or directly afterwards, another measurement 2 is taken by means of the second sensor at the reference point. This measurement 2 is also a measurement of the hydrogen-to-nitrogen ratio of the gas of the gas stream based on the thermal conductivity of the gas of the gas stream.

On the basis of the two measured hydrogen-to-nitrogen ratios at the two different points, the humidity of the gas of the gas stream is now determined 3. An evaluation 4 is then carried out to determine whether the humidity of the gas of the gas stream at the measuring point exceeds a threshold value. If this threshold value is not exceeded, the method is started over. However, if the threshold value is exceeded by the humidity of the gas of the gas stream at the measuring point, a flushing process is initialized 5 that flushes the gas stream with ambient air, as a result of which the humidity of the gas of the gas stream is greatly reduced. After the initialization 5 of the flushing process, the method is started over.

The exemplary embodiments of the figures in particular have no limiting character and serve to illustrate the concept of the disclosure.

### LIST OF REFERENCE SIGNS

1 measurement
2 measurement
3 ascertainment
4 evaluation
5 initialization
6 vehicle
7 fuel cell system
8 channel
9 first sensor
10 second sensor
11 control unit
12 computer program
13 computer-readable medium

What is claimed is:

1. A method for ascertaining a humidity of a gas stream at a measuring point in a fuel cell system comprising the measuring point and a reference point, chosen such that the gas stream has approximately equal hydrogen-to-nitrogen ratios at the reference point and the measuring point,
the reference point chosen such that the gas stream has a known humidity at the reference point, the method comprising:
measuring the hydrogen-to-nitrogen ratio of the gas stream at the measuring point using a first sensor;
measuring the hydrogen-to-nitrogen ratio of the gas stream at the reference point using a second sensor; and
ascertaining the humidity of the gas stream at the measuring point based at least in part on difference between the first and the second hydrogen-to-nitrogen ratio.

2. The method as claimed in claim 1, wherein the two sensors measure the hydrogen-to-nitrogen ratios based at least in part on thermal properties of the gas stream.

3. The method as claimed in claim 1, wherein the two sensors are calibrated identically.

4. The method as claimed in claim 1, further comprising:
initializing a flushing process if the humidity of the gas stream at the measuring point exceeds a threshold value.

5. The method as claimed in claim 1, further comprising
initializing a load-point-controlled or time-dependent flushing process if at least one of the sensors has a malfunction.

6. The method as claimed in claim 1, further comprising:
performing a diagnosis on the two sensors by temporarily forming the gas stream by way of a moistureless reference gas; and
identifying a malfunction in at least one of the two sensors based at least in part on a measurement signal difference between the two sensors.

7. A fuel cell system comprising:
a control unit;
a first sensor at a measuring point; and
a second sensor a reference point chosen such that a gas stream passing the measuring point and the reference point has an approximately equal hydrogen-to-nitrogen ratio at the reference point and the measuring point;
the reference point chosen such that the gas stream has a known humidity at the reference point;
wherein the control unit: determines the hydrogen-to-nitrogen ratio of the gas stream at the measuring point using a first sensor, measures the hydrogen-to-nitrogen ratio of the gas stream at the reference point using a second sensor, and ascertains the humidity of the gas stream at the measuring point based at least in part on a difference between the first and the second hydrogen-to-nitrogen ratio.

8. A vehicle comprising:
at least one wheel;
a fuel cell system driving the at least one wheel;
a control unit;
a first sensor at a measuring point in the fuel cell system; and
a second sensor at 10 reference point in the fuel cell system chosen such that a gas stream passing the measuring point and the reference point has an approximately equal hydrogen-to-nitrogen ratio at the reference point and the measuring point;
the reference point chosen such that the gas stream has a known humidity at the reference point;
wherein the control unit: determines the hydrogen-to-nitrogen ratio of the gas stream at the measuring point using a first sensor, measures the hydrogen-to-nitrogen ratio of the gas stream at the reference point using a second sensor, and ascertains the humidity of the gas stream at the measuring point based at least in part on a difference between the first and the second hydrogen-to-nitrogen rat

9-10. (canceled)
